(19) United States
(12) Patent Application Publication
(10) Pub. No.: US 2021/0300327 A1
(43) Pub. Date: Sep. 30, 2021

(54) HEAVY TRUCK HYBRID POWER SYSTEM AND CONTROL METHOD

(71) Applicant: Valvoline Licensing and Intellectual Property, LLC, Lexington, KY (US)

(72) Inventors: Roger D. England, Lexington, KY (US); Frances E. Lockwood, Georgetown, KY (US); Adam E. Sworski, Catlettsburg, KY (US); Michael Ray Wedding, Lexington, KY (US); Jason Alan Head, Lexington, KY (US)

(73) Assignee: Valvoline Licensing and Intellectual Property, LLC, Lexington, KY (US)

(21) Appl. No.: 16/831,255

(22) Filed: Mar. 26, 2020

(51) Int. Cl. B60W 20/14; B60K 1/04

(52) U.S. Cl. CPC B60W 20/14; B60K 2001/001; B60W 2300/125; B60K 1/04

(57) ABSTRACT

A heavy hybrid truck is powered by a non-electric powered medium and an electric powered axle. The electric powered axle assists the non-electric powered medium when load changes are detected. The electric powered axle is sourced by a rechargeable battery. The non-electric powered medium is either a fossil fuel combustion engine, a biofuel engine, a hydrogen engine, or a combination.

### TECHNICAL FIELD

This disclosure relates to a field of heavy truck hybrid power system and control method.

### BACKGROUND

Hybrid vehicles are usually powered by a combination of a combustion engine and an electric powered motor. The electric motor is powered by a battery, and the electric motor may be coupled to a common drive axle of the vehicle. The common drive axle may be driven by power generated by both the electric motor and the combustion engine. When the hybrid vehicle is moved from rest position or accelerated from a lower speed to a higher speed, the drive axle of the hybrid vehicle may be powered by the electric motor, and at cruising speed or downhill, the drive axle may be powered by the combustion engine. Hybrid vehicles in this regard, enjoy a performance improvement during acceleration and a better gas mileage with lower carbon emission.

Heavy trucks or semi-trucks, which are classified as class 7 or class 8 commercial trucks are based on a gross vehicle weight rating (GVWR), are powered by combustion engines which are rated at more than 400 horse power without a reduction in engineH size for concerns of engine damages and poor drivability control.

### BRIEF DESCRIPTION OF DRAWINGS

The disclosure is better understood with reference to the following drawings and description. The elements in the figures are not necessarily to scale, emphasis are instead being placed upon illustrating the principles of the disclosure. Moreover, in the figures, like-referenced numerals may designate to corresponding parts throughout the different views.

FIG. 1A illustrates a hybrid heavy truck using a non-electric powered medium truck engine and an electric powered axle.

FIG. 1B shows a top view of the hybrid heavy truck.

FIG. 2 illustrates a control system of the hybrid heavy truck.

FIG. 3 illustrates dynamic interactions between the electric powered axle and the non-electric powered medium truck engine in the hybrid heavy truck.

FIG. 4 illustrates an example of a method that powers a hybrid heavy truck.

### DETAILED DESCRIPTION

In the following, only certain examples are briefly described. As those in the art would realize, the described examples may be modified in various different ways, all without departing from the spirit or scope of the present disclosure.

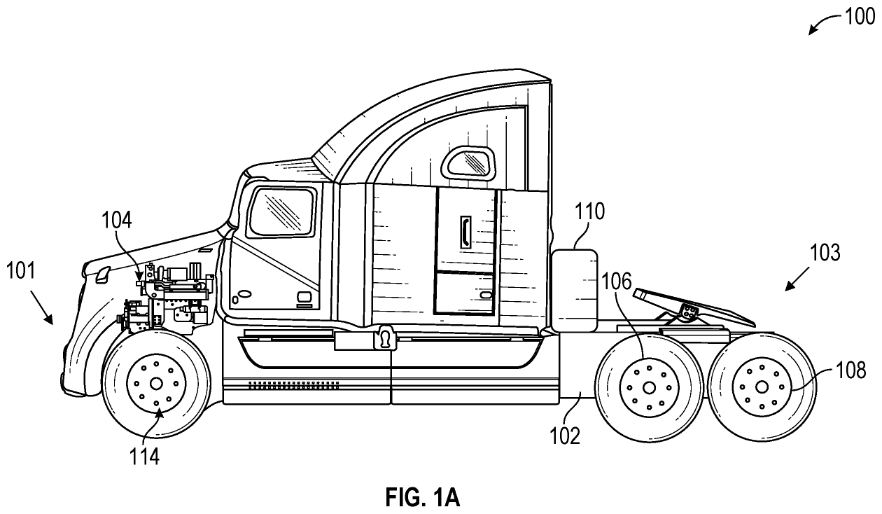

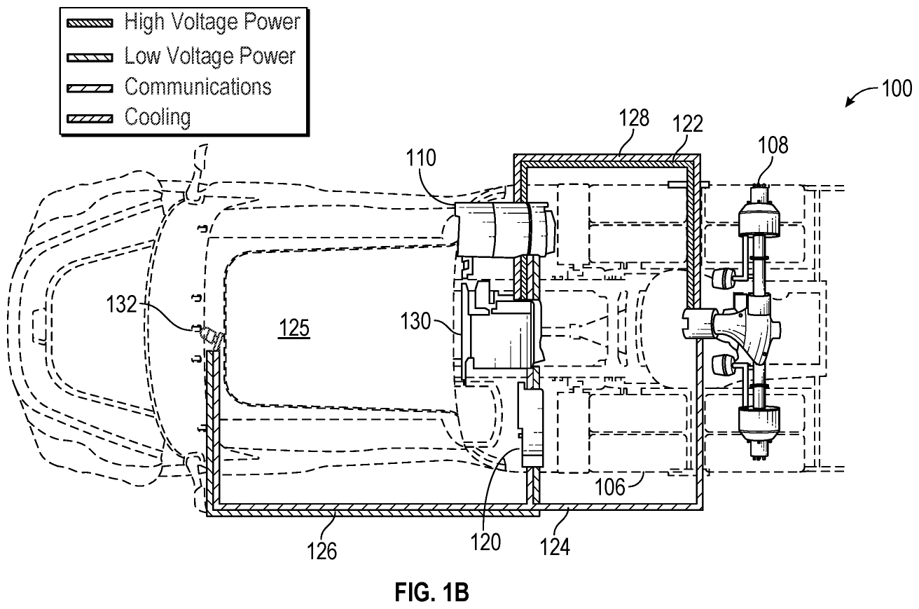

FIG. 1A illustrates a hybrid heavy truck 100 using a non-electric powered medium truck engine 104 and an electric powered axle 108. The hybrid heavy truck 100 may be classified as a class 7 or a class 8 commercial truck based on a gross vehicle weight rating (GVWR). In an example, hybrid heavy truck 100 may be installed with a reduced size combustion engine 104 which may be a medium combustion truck engine rated at less than 380 HP (typically 250 HP), compared with a heavy truck with a full engine size of between 400-600 HP. The heavy truck 100 may include a steering system 114 coupled to a forward end 101 of a heavy truck chassis 102 to facilitate steering.

The non-electric powered medium truck engine 104 may be mounted near the forward end 101 of the heavy truck chassis 102, a drive axle 106 which is mounted near a rear end 103 of the heavy truck chassis 102, is coupled to the non-electric powered medium truck engine 104. An electric powered axle 108 is positioned closer to the rear end 103 of the heavy truck chassis 102 after the drive axle 106 as an added axle or a replaceable axle.

The non-electric powered medium truck engine 104 which is rated between 250 to 380 horse power may be one of a gasoline engine, a diesel engine, a propane engine, a natural gas engine, an ethanol engine, a biofuel engine, or a hydrogen engine.

The electric powered axle 108 is powered by current sourced by a rechargeable battery 110. A control system 120 having a processor 222 executes a program or an application 224 stored in a memory 226, controls when and how much current may be sourced to power the electric powered axle 108 to assist the non-electric powered medium truck engine 106 and to engage the drive axle 106 to recharge the rechargeable battery 110 during vehicle deceleration.

In an example, the rechargeable battery 110 may include a bank of batteries of a same type connected in parallel to increase current output. The types of rechargeable battery 110 may be at least anyone of: a Lithium Ion battery, a Molten Salt battery, a Nickel Metal Hydride battery, a Lithium Sulphur battery and a Lead-Acid battery, or any similar types with a high power density that can deliver high current throughput and can be rapidly recharge in a short time. The charge storage capacity of the rechargeable battery 110 may be rated at a minimum of at least 100 kWh. The recharging of the rechargeable battery 110 may be performed at home, at a dedicated electrical charging station or recharged locally while driving through an in-vehicle regenerative charging system such as through regenerative braking or from conversion of mechanical energy into electrical current for recharging.

FIG. 1B shows a top view of the hybrid heavy truck 100. The control system 120 may be situated at a location which is protected from t or open environment exposure or from damage. In an example, the control system 120 may be located near a rear end of the chassis 102 near the battery 110. In another example, the control system 120 may be situated within a driver cabin 125. The control system 120 may display relevant vehicle operations information to the driver at a display 132 through a communication bus 124. The control system 120 may provide control functions and monitoring functions to the rechargeable battery 110, the electric powered axle 108 and to a thermal management unit 130 through the communication bus 124 and connections to a low voltage power bus 126. The rechargeable battery 110 may supply electric current to the electric powered axle 108 through a high voltage power bus 122 and the electric powered axle 108 may be cooled by the thermal management unit 130 through cooling line 128.

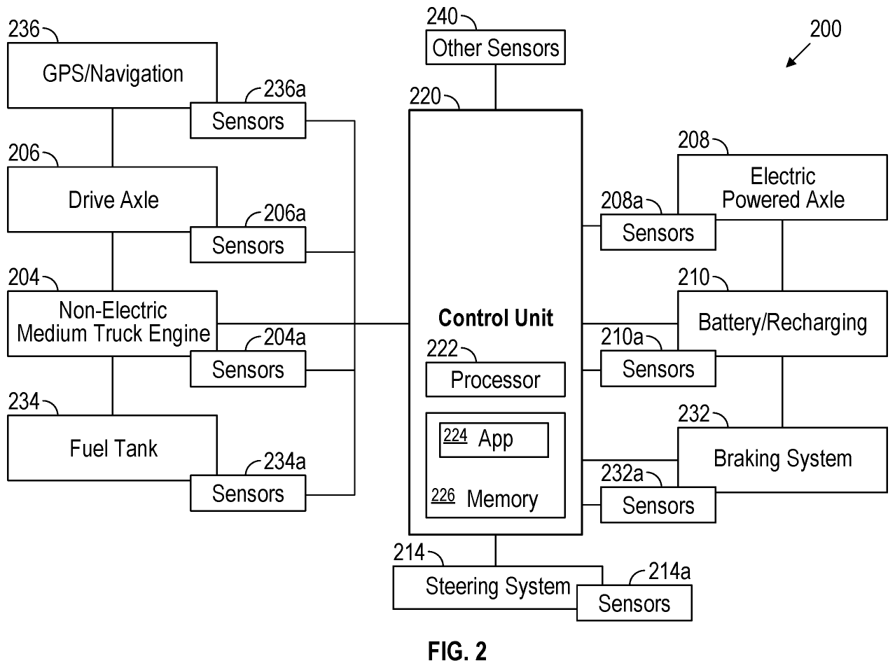

FIG. 2 illustrates a control system 200 of the hybrid semi-truck 100. The control system 200 may include a control unit 220 and a plurality of sensors. The control unit 220 may be an on-board computer having at least a processor 222 that executes one or more applications 224 stored in a computer-readable-medium such as a memory 226, to configure the electric powered axle 108 to supplement the non-electric powered medium truck engine 104 to power the heavy truck 100. The plurality of sensors may include a powertrain sensor 204a that monitors a combination of engine torque, engine revolutions per minute (RPM), a drive axle sensor 206a that monitors drive axle revolutions, a fuel tank sensor 234a that monitors a fuel level, a GPS receiver/sensor 236a for navigation, a steering wheel sensor 214a to monitor steering wheel angle, a braking sensor 232a that monitors braking to activate regenerative braking recharging (i.e., reverse flow of current by mechanical energy conversion) for the rechargeable battery 210, a battery sensor 210a to monitor battery charge level and current flow, electric powered axle sensors 208a that monitor both transformers temperature and rotations of the electric powered axle 208, etc. Other sensors 240 may include an output of a throttle position sensor and a barometric pressure sensor for oil pressure, and a gyroscope for orientation detection.

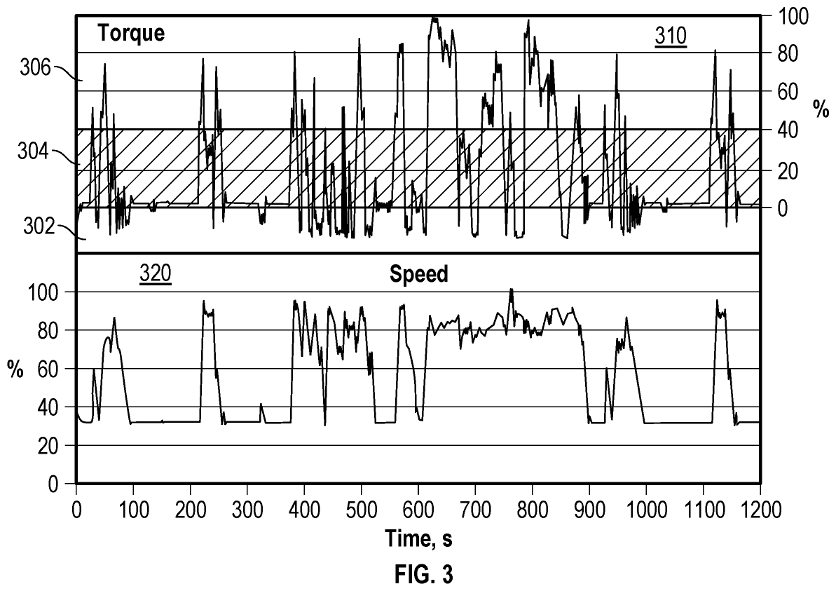

FIG. 3 illustrates dynamic interactions between the electric powered axle 108 and the non-electric powered medium truck engine 104 in the hybrid semi-truck 100. FIG. 3 shows a plot of torque versus time in an upper graph portion 310 and a plot of vehicle speed versus time in a lower graph portion 320. Referring to the upper graph portion 310, the y-axis represents a percentage displacement of torque generated for the non-electric powered medium truck engine 104 and the x-axis represents time (in seconds). Referring to the lower graph portion 320, the y-axis represents a percentage of engine speed for the non-electric powered medium truck engine 104 and the x-axis represents time (in seconds). The lower graph portion 320 is used to track the operations of the upper graph 310, which therefore requires no further description.

In practice, an output torque under a 40% torque displacement may be set as an upper threshold. When the hybrid heavy truck 100 is at cruising speed operating in region 304 under the 40% torque displacement threshold, the hybrid heavy truck 100 may be sufficiently powered by only the non-electric powered medium truck engine 104 (e.g., internal combustion engine). However, when the heavy truck is moving from a rest position, starts climbing a hill or is passing another vehicle, the non-electric powered medium truck engine 104 needs to supply additional power to meet the power requirement by increasing torque in the underpowered non-electric powered medium truck engine 104. The powertrain sensor 204a may send out a signal to the control unit 120 to indicate that the engine torque has exceeded the upper torque threshold.

The control unit 120 may transmit a command through the communication bus 124 to enable the battery 110 to source an amount of current to drive the electric powered axle 108 to reduce the burden and the wearing of the non-electric powered medium truck engine 104 in region 306, by lowering the torque displacement percentage to sufficiently close to or below the 40% torque displacement threshold. In brief, the dynamics of coordination between the underpowered non-electric powered medium truck engine 104 and the electric powered axle 108 may be accomplished through power peaking detection or torque spiking detection over a defined time duration as shown in FIG. 3.

In a case when the control unit 120 detects a zero torque displacement or a negative torque displacement during downhill or deceleration caused by braking, the control unit 120 may activate regenerative charging functions in the regenerative braking system 232 in the wheels to help slow down the hybrid heavy truck 100 and to recharge the battery 210. In a case when the battery 210 indicates that it is below a specified level in charge, the control unit 120 may force charge the battery through generating excess power from the non-electric powered medium truck engine 104.

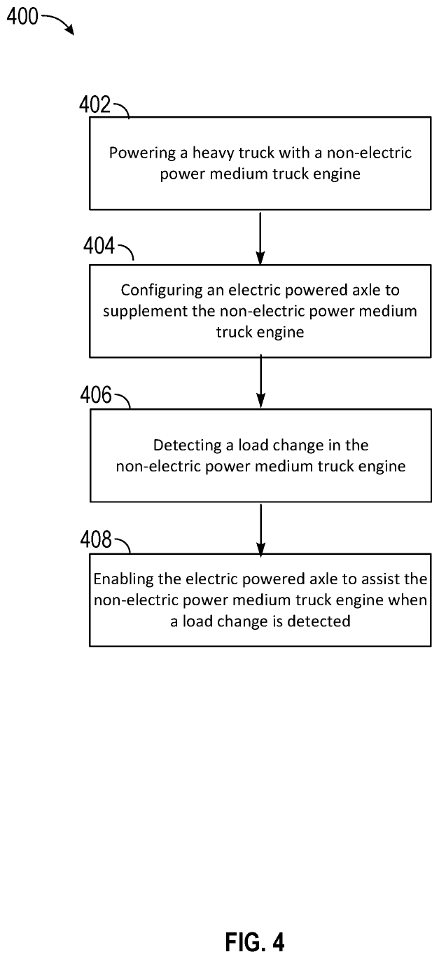

FIG. 4 illustrates an example of a method that powers a hybrid heavy truck. In step 402, the method includes powering a heavy truck 100 with a non-electric powered medium truck engine 104. In step 404, configuring by a controller 120, an electric powered axle 108 to supplement the non-electric powered medium truck engine 104. In step 406, detecting by at least a sensor, a load change in the non-electric powered medium truck engine 104. Step 408, enabling by the controller 120, the electric powered axle 108 to assist the non-electric powered medium truck engine 104 when a load change is detected.

In practice, the heavy truck 100 may be classified as a class 7 or a class 8 commercial truck based on gross vehicle weight rating and the non-electric powered medium truck engine 104 is rated to output less than 380 horse power. The non-electric powered medium truck engine 104 may be powered by a gasoline engine, a diesel engine, a propane engine, a natural gas engine, an ethanol engine, a biofuel engine, or a hydrogen engine. The rechargeable battery 110 may be a battery bank including one or a combination of: Lithium Ion battery, Molten Salt battery, Nickel Metal Hydride battery, Lithium Sulphur battery or a Lead-Acid battery. The rechargeable battery 110 has a minimum capacity rating of at least 100 kWh, which may be rechargeable through a charging station or an in-vehicle regenerative charging system.

The control system 200 may be coupled to a plurality of sensors which detect events that determine when to apply electric current to the electric power axle. The plurality of sensors include one or more powertrain sensor that monitors one or both of engine torque and revolutions per minute. The control system 200 may transmit a command that enables the battery 110 to source electric current to the electric powered axle 108 in response to an output from a throttle position sensor 204a or an output from a barometric pressure sensor. The control system 200 that transmits commands that enables the battery 110 to substantially reduce or completely cut off the electric current sourcing the electric powered axle 108 in response to a change in a load event. Such change in the load event may be detecting a spike of the torque for a defined time duration.

The cost reduction in installing a medium truck engine 104 into a heavy truck and the reduction in weight in using a medium truck engine more than offset the cost and the added weight and of the rechargeable battery 110. Furthermore, the use of a medium truck engine and the electric powered axle improves the fuel economy of the heavy truck and substantially reduce the carbon emissions of the heavy truck.

Other systems, methods, features and advantages will be, or will become, apparent to one with skill in the art upon examination of the figures and detailed description. It is intended that all methods, features included within this description, be protected by the following claims.

We claim:

1. A heavy truck powered by a reduced size engine, comprises:
a steering system coupled to a forward end of a heavy truck chassis to facilitate steering;
a non-electric powered medium truck engine mounted near the forward end of the heavy truck chassis;
a drive axle which is near a rear end of the heavy truck chassis, is coupled to the non-electric powered medium truck engine;
an electric powered axle positioned closer to the rear end of the heavy truck chassis after the drive axle;
a rechargeable battery coupled to and powering the electric powered axle; and
a control system, comprising a processor that executes a program stored in a memory, engages the electric powered axle to supplement power to the non-electric powered medium truck engine and engages the drive axle to recharge the rechargeable battery during vehicle deceleration.

2. The heavy truck of claim 1, where the heavy truck is classified as a class 7 or a class 8 commercial truck based on a gross vehicle weight rating.

3. The heavy truck of claim 1, wherein the non-electric powered medium truck engine is rated at less than 380 horse power.

4. The heavy truck of claim 3, wherein the non-electric powered medium truck engine is powered by a gasoline engine, a diesel engine, a propane engine, a natural gas engine, an ethanol engine, a biofuel engine, or a hydrogen engine.

5. The heavy truck of claim 1, wherein the rechargeable battery comprises a battery bank comprising one or a combination of: a Lithium Ion battery, a Molten Salt battery, a Nickel Metal Hydride battery, a Lithium Sulphur battery or a Lead-Acid battery.

6. The heavy truck of claim 5, wherein the rechargeable battery has a minimum capacity rating of at least 100 kWh, and the rechargeable battery is rechargeable through a charging station or an in-vehicle regenerative charging system.

7. The heavy truck of claim 1, wherein the control system is coupled to a plurality of sensors which detect events that determine when to apply electric current to the electric power axle.

8. The heavy truck of claim 7, wherein the plurality of sensors comprises one or more powertrain sensors to monitor one or both of engine torque and revolutions per minute.

9. The heavy truck of claim 8, wherein the control system transmits commands that enables the battery to source electric current to the electric powered axle in response to an output of a throttle position sensor and a barometric pressure sensor.

10. The heavy truck of claim 8, wherein the control system transmits commands that enables the battery to substantially reduce or completely cut off the electric current sourcing the electric powered axle in response to a change in a load event.

11. A method that powers a heavy truck, comprising:
enabling a non-electric powered medium truck engine to power a heavy truck, wherein the non-electric powered medium truck engine is mounted near a forward end of a heavy truck chassis, wherein a drive axle which is near a rear end of the heavy truck chassis, is coupled to the non-electric powered medium truck engine;
configuring an electric powered axle to supplement the non-electric powered medium truck engine to power the heavy truck, wherein the electric powered axle is positioned closer to the rear end of the heavy truck chassis after the drive axle, wherein a rechargeable battery is coupled to and powers the electric powered axle; and
enabling by a control system, an electric powered axle to assist the non-electric powered medium truck engine, and engaging the drive axle to recharge the rechargeable battery during vehicle deceleration.

12. The method of claim 11, wherein the heavy truck is classified as a class 7 or a class 8 commercial truck based on gross vehicle weight rating.

13. The method of claim 11, wherein the non-electric powered medium truck engine is rated at least 380 horse power.

14. The method of claim 13, wherein the non-electric powered medium truck engine is powered by a gasoline engine, a diesel engine, a propane engine, a natural gas engine, an ethanol engine, a biofuel engine, or a hydrogen engine.

15. The method of claim 11, wherein the rechargeable battery comprises a battery bank comprising one or a combination of: Lithium Ion battery, Molten Salt battery, Nickel Metal Hydride battery, Lithium Sulphur battery or a Lead-Acid battery.

16. The method of claim 15, wherein the rechargeable battery has a minimum capacity rating of at least 100 kWh, and the rechargeable battery is rechargeable through a charging station or an in-vehicle regenerative charging system.

17. The method of claim 11, further comprising a control system coupled to a plurality of sensors which detect events that determine when to apply electric current to the electric power axle.

18. The method of claim 17, wherein the plurality of sensors comprises one or more powertrain sensor that monitors one or both of engine torque and revolutions per minute.

19. The method of claim 18, further comprising a control system that transmits commands that enables the battery to source electric current to the electric powered axle in response to an output from a throttle position sensor or an output from a barometric pressure sensor.

20. The method of claim 18, wherein the control system transmits commands that enables the battery to substantially reduce or completely cut off the electric current sourcing the electric powered axle in response to a change in a load event.
